(19) United States
(12) Patent Application Publication
(10) Pub. No.: US 2009/0080903 A1
(43) Pub. Date: Mar. 26, 2009

(54) Optical transmitter with precisely controlled laser diode and a method to control a temperature of a laser diode

(76) Inventor: Ichino Moriyasu, Yokohama-shi (JP)

Correspondence Address: SMITH, GAMBRELL & RUSSELL, 1130 CONNECTICUT AVENUE, N.W., SUITE 1130, WASHINGTON, DC, 20036, US

(21) Appl. No.: 11/902,959

(22) Filed: Sep. 26, 2007

(51) Int. Cl. H04B 10/135; H01S 3/00

(52) U.S. Cl. 398/182; 372/34

(57) ABSTRACT

The present invention discloses an optical transmitter that enables to precisely control the temperature of the LD and to keep the emission wavelength constant. The controller installed within the transmitter includes a control signal generator, a differential amplifier and a current driver. The signal generator generates a control signal based on the current provided to the TEC and the outside temperature of the optical module. The differential amplifier differentiates the control signal from the inside temperature with in the module to generate a differential signal. The current driver, based on the differential signal, provides the current to the TEC.

### BACKGROUND OF THE INVENTION

1. Field of the Invention

The present invention relates to a method to control a temperature of a laser diode (hereafter denoted as LD).

2. Related Prior Art

The emission wavelength of the LD depends on the temperature thereof and the driving current provided thereto. Accordingly, it is inevitable to control the temperature of the LD in addition to keep the driving current constant. Various methods have been disclosed by, for example, a Japanese Patent published as JP-2004-289075A. The optical transmitter disclosed therein includes an optical module that installs an LD, a temperature sensor and a thermo-electric cooler (hereinafter denoted as TEC), and a controller to carry out the compensation of the temperature characteristic of the LD. This optical transmitter carries out the compensation by the temperature sensed by the temperature sensor and the information relating to the operation. The transmitter provides an additional sensor that senses a temperature outside of the module, and derives the information relating to the operation from this additional sensor.

The temperature sensor within the module only senses the temperature around the LD, not the practical temperature of the LD itself. The LD and the sensor set immediate to the LD are influenced from heat not only from the LD itself but also from various thermal sources around the LD. Accordingly, it is preferable to equalize the influence on the LD from the thermal source to that on the sensor in order to precisely control the temperature of the LD.

The LD and the temperature sensor are set on independent positions, accordingly, the influence of the thermal source to the LD and that to the sensor become different to each other. Therefore, it is quite difficult to precisely control the temperature of the LD by the temperature sensor not compensated to the thermal source around the LD, which consequently becomes hard to keep the emission wavelength of the optical transmitter constant.

### SUMMARY OF THE INVENTION

One aspect of the present invention relates to an optical transmitter that provides an optical module, which installs a LD, a first temperature sensor and a TEC, a second temperature sensor, a current monitor, a control signal generator, a differential amplifier, and a current generator. The first temperature sensor senses the temperature of the LD, which is the inside temperature. The TEC controls the temperature of the LD. The second temperature sensor senses the outside temperature of the optical module. The current monitor monitors the magnitude of the driving current supplied to the TEC. The control signal generator generates a control signal, which corresponds to a corrected temperature, to set the temperature of the LD in a preset temperature based on the driving current and the outside temperature. The differential amplifier generates a difference signal between the control signal and the inside temperature of the module. The current generator generates the driving current supplied to the TEC based on the difference signal.

Because the optical transmitter of the invention is thus configured, the temperature of the LD may be precisely controlled taking the outside temperature and the driving current supplied to the TEC into account and the emission wavelength of the transmitter may be kept constant even the outside temperature changes.

Another aspect of the present invention relates to a method to precisely control the temperature of the LD. The method comprises the steps of: (a) sensing the outside temperature, (b) monitoring the driving current supplied to the TEC, (c) generating the control signal based on the outside temperature, the driving current and the present temperature of the laser diode, (d) differentiating the control signal from the temperature of the LD, and (e) providing the driving current based on the difference between the control signal and the temperature of the LD.

Because the method according to the present invention is thus configured, the temperature of the LD may be precisely controlled taking the outside temperature and the driving current supplied to the TEC into account and the emission wavelength of the transmitter may be kept constant even the outside temperature changes.

### BRIEF DESCRIPTION OF DRAWINGS

FIG. 1 is a schematic and functional drawing of an optical transmitter according to an embodiment of the invention; and

FIG. 2 is a block diagram of the controller installed within the optical transmitter shown in FIG. 1.

### DETAILED DESCRIPTION OF THE INVENTION

Next, embodiments of the present invention will be described as referring to accompanying drawings. The same symbols or the same numerals in the drawings will refer to the same elements without overlapping explanations.

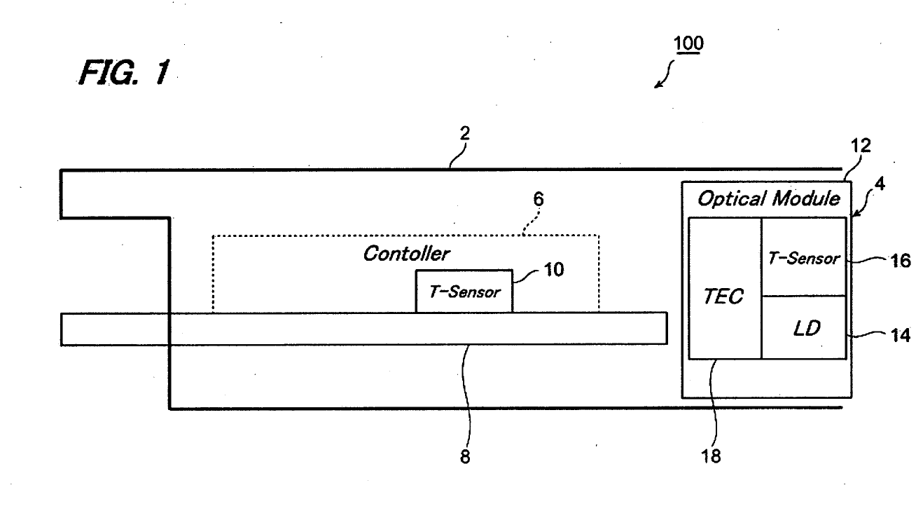

FIG. 1 is a schematic functional drawing of an optical transmitter 100 according to an embodiment of the invention. The optical transmitter 100 provides a housing 2, an optical module 4, a controller 6 and a substrate 8. The housing 2 installs the optical module 4, the controller 6 and the substrate 8 therein. The substrate mounts the controller 6, which provides a temperature sensor 10. This temperature sensor 10, which is installed on the outside of the package 12 of the optical module 4, senses an ambient temperature within the housing 2, in other words, the outside temperature of the optical module 4. The rear end of the substrate 8 extrudes from the rear of the housing, while, the front end of the substrate 8 mounts the optical module 4 thereon, and the optical module 2 couples with an optical fiber through an optical connector, both of which are not illustrated in FIG. 1.

The optical module 4 provides the package 12, the laser diode (hereafter denoted as LD) 16, and thermo-electric cooler (hereafter denoted as TEC) 18. The LD 16 and the TEC 18 are installed within the package 12. The LD 12 emits light based on the current supplied thereto. The emission wavelength depends on the temperature of the LD 14. The TEC mounts the LD 12 thereon to control the temperature of the LD 14. The TEC heats up or cools down the upper plate thereof, where the LD 14 is mounted, by supplying the driving current A6. The heating up or the cooling down of the TEC depends on the direction of the supply current A6. Another temperature sensor 16 senses the inside of the package 12 of the module 4. Specifically, the optical module 4 sets the sensor 16 immediate to the LD 14 to sense the ambient temperature of the LD 14.

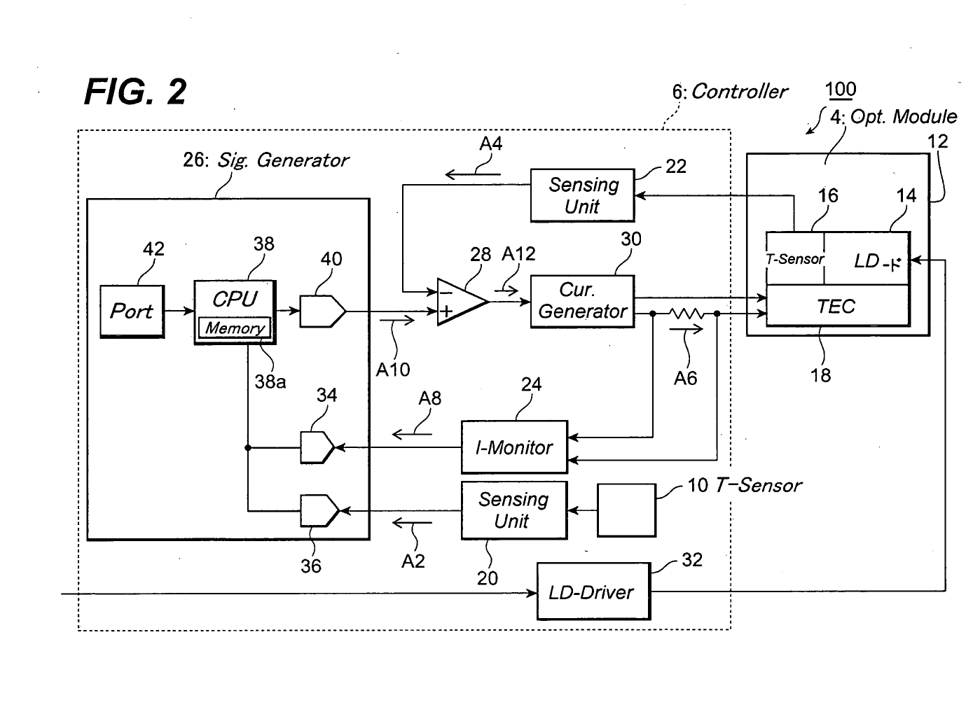

FIG. 2 is a block diagram of the controller 6 shown in FIG. 1. The controller 6 provides the temperature sensor 10, a sensing unit 20 for the sensor 10, another sensing unit for the sensor 16 within the module 4, a current monitor 24, a signal generator 26 for the temperature compensation, a differential amplifier 28, a current driver 30 and the LD driver 32.

The sensing unit 20 provides a signal A2 corresponding to the outside temperature T2 to the signal generator 26. The other sensing unit 22 provides a signal A4, which corresponds to the inside temperature T1 sensed by the sensor 16 immediate to the LD 14, to the inverting input of the differential amplifier 28. The current monitor 24 monitors the driving current A6 to drive the TEC 18, and provides a signal A8 corresponding to the monitored current A6 to the signal generator 26.

The signal generator 26 generates a signal corresponding to the corrected temperature T_{COM} to set the temperature of the LD 14 to be a predetermined temperature T_{S} based on the current A6 output from the current monitor 24 and the outside temperature T2 provided from the temperature sensor 10. The signal generator 26 provides an analog signal A10 that corresponds the corrected temperature T_{COM} to the non-inverting input of the differential amplifier 28 via the digital-to-analog converter (hereafter denoted as D/A-C) 40.

The differential amplifier 28, when the gain thereof is enough large, operates so as to output a control signal A12 to the driver 30 to equalize the inside temperature T1 in the package 12, which is sensed by the sensor 16, to the corrected temperature T_{COM}. The driver 30, depending on the signal A12, generates the driving current A6 and outputs the current A6 to the TEC 18. The TEC heats up or cools down depending on the direction of the driving current, and the inside temperature T1 finally becomes the reference temperature. The LD driver 32 drives the LD 14 by providing the driving current thereto.

The signal generator 26 may further include analog-to-digital converters (hereafter denoted as A/D-C), 34 and 36, a CPU 38, a D/A-C and a communication port 42. The A/D-C converts the monitored signal A8, which is in analog form and output from the sensing unit 20, to a digital form, and provides this digitized signal toe the CPU 38. The communication port 42 is an interface to communicate with the outside of the transmitter. The port 42 may receive the information about the preset temperature T_{S} of the LD 14.

The CPU 38, including a memory 38a, may save the information such as the preset temperature T_{S}, which is received from the outside of the transmitter 100 through the port 42, into the memory 38a. The CPU 38 calculates the corrected temperature T_{COM} from the preset temperature T₃, the signal corresponding to the monitored signal A8 provided through the A/D-C 34, and the signal A2 corresponding to the outside temperature and provided through the other A/D-C 36. The CPU 38 outputs thus calculated digital signal that reflects the corrected temperature T_{COM} to the D/A-C 40. The D/A-C 40 converts this digital signal into an analog form A10 to output this analog signal to the non-inverting input of the differential amplifier 28.

The corrected temperature may be estimated by a function;

T_{COM}=α×(T2+β×S2−Ts)+TS

where, T2 is the outside temperature the sensor T10 senses, S2 is the driving current A6 for the TEC 18, and TS is the preset temperature of the LD 14. Specifically, when the wavelength division multiplexing (hereafter denoted as WDM) applies the transmitter 100, the preset temperature Ts is the temperature where the LD 14 in the emission wavelength thereof is on one grid wavelength following the WDM standard.

The proportionality constants, α and β, depend on the arrangement of the optical module 4. That is, the constant α relates to a contribution of the heat from the package 12 to the difference between the temperature of the LD 14 and the that sensed by the sensor 16 due to the thermal resistance of the LD 14 and the sensor 16. The heat, in other words, the thermal flux from the package 12 depends on the temperature difference between the inside of the optical module 14 and the outside thereof. The outside temperature of the module 4 adds the temperature increase β×S2 due to the driving current A6 to the outside ambient temperature T2. The coefficient β is an electrical-to-thermal conversion parameter of the driving current A6, whose magnitude is S2, flowing in the TEC 18 to increase the temperature of the package 12.

The practical temperature T_{LD} of the LD 14 is generally different from the inside temperature T1, namely, the temperature sensed by the sensor 16. The thermal source around the LD 14 causes the temperature difference ΔT between the inside temperature T1 and that of the LD 14 T_{LD}. The thermal source around the LD 14 may be, at least, the outside ambient temperature of the module 4 and the driving current A6. Accordingly, the corrected temperature T_{COM} is necessary to take this temperature difference ΔT into account. Thus, the corrected temperature T_{COM} may be obtained by adding the temperature difference ΔT to the preset temperature T_{S}.

In the characteristic equation above, the ambient temperature T2 sensed by the sensor 10 adding summed up with the temperature β×S2 due to the current A6, the magnitude of which is S2, providing to the TEC 12 multiplied by the coefficient β reduces the temperature of the package. Thus, the preset temperature Ts subtracted from the temperature corresponding to the package temperature described above results in the thermal source around the LD 14, and this thermal source is proportional to the temperature difference ΔT with the parameter α as the proportional constant.

The proportional constant α may be calculated from the relation of the difference ΔT to the difference between the package 12 and the LD 14. For instance, when the emission wavelength shifts by 10 pm (pico-meter) under a condition where the outside ambient temperature varies by 100° C. in an optical module where the emission wavelength thereof changes by 100 pm by adjusting the preset temperature by 1° C. without any corrected temperature T_{COM}, the temperature of the LD 14 practically shifts by 0.1° C. In this case, the proportional constant α becomes 0.1/100=0.001. Next, because the co-efficient β relates to the temperature increase by the driving current, the parameter β may be estimated by sensing the practical increase of the package temperature when an amount of the driving current is provided to the TEC 18.

Accordingly, the CPU 38 may compensate the temperature to be set to the TEC 18, namely, the influence from the thermal source around the LD 14 which is contained in the inside temperature T1, by evaluating the constants α and β in advance to the practical operation of the transmitter 100.

Because the equation above is a linear with parameters of the outside ambient temperature T2 and the driving current S2, the CPU may process concerning to the equation. The signal generator 26 may store the information of the corrected temperature T_{COM} in the memory 38a as a function of the preset temperature TS, the driving current A6 and the ambient temperature T2. In this arrangement, the CPU 38 may carry out the estimation of the corrected temperature T_{COM} only by referring to the information saved within the memory 38a without calculating in accordance with the equation above, which lessens the load of the CPU 38.

Thus, the inside temperature T1 sensed by the sensor 16 depends not only on the inside thermal source but also on the outside source and the driving current A6 provided to the TEC 18. The corrected temperature T_{COM} takes the preset temperature TS, the outside temperature T2 sensed by the sensor 10, and the current A6 supplied to the TEC 18 into account.

Accordingly, the temperature difference ΔT between the inside temperature T1 sensed by the sensor 16 and the corrected temperature T_{COM} becomes the temperature difference between the temperature sensed by the sensor 16 and the preset temperature Ts, because the heat from the outside of the module 4 and that due to the driving current provided to the TEC 18 are compensated. The present transmitted thus corrects the temperature of the LD 14, which enables to precisely control the temperature of the LD 14; accordingly, the emission wavelength of the optical transmitter may be kept constant independent of the outside temperature of the module 4.

While the preferred embodiments of the present invention have been described in detail above, many changes to these embodiments may be made without departing from the true scope and teachings of the present invention. The present invention, therefore, is limited only as claimed below and the equivalents thereof.

I claim:

1. An optical transmitter comprising:
an optical module that installs a laser diode, a thermo-electric-cooler to control a temperature of the laser diode, a first temperature sensor to sense the temperature of the laser diode;
a second temperature sensor installed outside of the optical module, the second temperature sensor sensing an outside temperature of the optical module;
a current monitor to monitor a driving current supplied to the thermo-electric-cooler;
a control signal generator to generate a control signal to set the temperature of the laser diode in a preset temperature based on the driving current monitored by the current monitor and the outside temperature sensed by the second temperature sensor;
a differential amplifier to generate a difference signal between the control signal generated by the control signal generator and the temperature of the laser diode sensed by the first temperature sensor; and
a current generator to generate the driving current supplied to the thermo-electric-cooler based on the difference generated by the differential amplifier.

2. The optical transmitter according to claim 1,
wherein the control signal generator includes a memory that store the control signal in accordance with the preset temperature, the outside temperature and the driving current, and
wherein the control signal generator generates the control signal by accessing the memory based on the outside temperature sensed by the second temperature sensor, the driving current monitored by the current monitor, and the preset temperature.

3. A method to control a temperature of a laser diode installed in an optical module with a first temperature sensor that senses the temperature of the laser diode and a thermo-electric controller to control the temperature of the laser diode, the method comprising steps of:
sensing an outside temperature by a second temperature sensor;
monitoring a driving current supplied to the thermo-electric-cooler;
generating a control signal based on the outside temperature, the monitoring current and a preset temperature for the laser diode;
differentiating the control signal from the temperature of the laser diode sensed by the first temperature sensor; and
providing the driving current based on the difference between the control signal and the temperature of the laser diode.

4. The method according to claim 3,
wherein the step for generating the control signal includes a step to read the control signal from a memory where the control signal is saved in accordance with the outside temperature, the monitoring current and the preset temperature.
